(19) United States
(12) Patent Application Publication
(10) Pub. No.: US 2016/0019807 A1
(43) Pub. Date: Jan. 21, 2016

(54) VEHICLE RISKY SITUATION REPRODUCING APPARATUS AND METHOD FOR OPERATING THE SAME

(71) Applicant: JAPAN AUTOMOBILE RESEARCH INSTITUTE, Tokyo (JP)

(72) Inventors: Nobuyuki UCHIDA, Ibaraki (JP); Takashi TAGAWA, Ibaraki (JP); Takashi KOBAYASHI, Ibaraki (JP); Kenji SATO, Ibaraki (JP); Hiroyuki JIMBO, Ibaraki (JP)

(21) Appl. No.: 14/774,375

(22) PCT Filed: Oct. 29, 2013
(86) PCT No.: PCT/JP2013/079278

§ 371 Date: Sep. 10, 2015

(30) Foreign Application Priority Data
Mar. 12, 2013 (JP) 2013-049067

(51) Int. Cl. G09B 9/052; G09B 5/02; G09B 9/042

(52) U.S. Cl. CPC G09B 9/052; G09B 9/042; G09B 5/02

(57) ABSTRACT

A risky situation is reproduced in a direct visual field of a driver driving a vehicle with a high sense of reality. A vehicle position and attitude calculation unit calculates a present position and a traveling direction of the vehicle, a driving action detector detects an action performed by the driver driving the vehicle and the condition of the vehicle, a scenario generator generates a content, position, and timing of the risky situation occurring while the driver drives the vehicle, a virtual information generator generates visual virtual information indicating the risky situation, and a superimposing unit superimposes the generated virtual information on the image of the traveling direction of the vehicle shot by an imaging unit Then, an image display unit indicates the image on which the virtual information is superimposed in the direct visual field of the driver.

### TECHNICAL FIELD

The present invention relates to a vehicle risky situation reproducing apparatus disposed in a vehicle to reproduce a virtual risky situation in direct eyesight of a driver while driving an actual vehicle and a method for operating the same.

### BACKGROUND ART

It is important and effective to analyze an action of a driver when the driver encounters a risky situation while driving in order to clarify the cause of a traffic accident.

Recently, various safety systems for preventing a collision of a vehicle have been proposed. When developing such a new safety system, it is required in-advance to sufficiently analyze a performance of a driver in response to the operation of the safety system.

Since it is dangerous to use an actual vehicle for the above-described analysis of the action and performance of the driver, a method for reproducing a risky situation by using a driving simulator is frequently used (refer to Patent Literature 1).

### CITATION LIST

### Patent Literature

Patent Literature 1: JP2010-134101A

### SUMMARY

### Technical Problem

However, the driving simulator recited in Patent Literature 1 is dedicatedly used for virtual driving in a virtually imaged road environment, so a reality is lacked in the driving. Accordingly, the driver using the driving simulator may become conceited due to the lack of reality. Therefore, the driving simulator cannot always analyze the action of the driver accurately when the driver encounters the risky situation in an actual driving environment.

In addition, since the driving position of the driver and the performance of the vehicle in the driving simulator are different from those in an actual vehicle, it is difficult to appropriately evaluate effects of a driving support system and a safety system installed in the vehicle.

The present invention has been made in view of the above-described circumstances and aims to provide a vehicle risky situation reproducing apparatus that presents a virtual risky situation to a driver with high sense of reality while driving an actual vehicle.

More particularly, the present invention provides the vehicle risky situation reproducing apparatus capable of encouraging an improvement in driving technique by reproducing a risky situation according to the driving technique of the driver.

### Solution to Problem

A vehicle risky situation reproducing apparatus according to one embodiment of the present invention reproduces a virtual risky situation to a driver driving an actual vehicle by displaying an image on which a still image or a motion image configuring the virtual risky situation is superimposed in a positon that interrupts a direct visual filed of the driver in the actually traveling vehicle.

The vehicle risky situation reproducing apparatus according to one embodiment of the present invention includes an imaging unit mounted on an actually traveling vehicle to shoot an image in a traveling direction of the vehicle; an image display unit disposed to interrupt a direct visual field of a driver of the vehicle to display the image shot by the imaging unit; a vehicle position and attitude calculation unit that calculates a present position and a traveling direction of the vehicle; a driving action detector that detects a driving action of the driver while driving the vehicle; a scenario generator that generates a risky situation indication scenario including a content, a position and a timing of a risky situation occurring while the driver drives the vehicle based on a detection result of the driving action detector and a calculation result of the vehicle position and attitude calculation unit; a virtual information generator that generates visual virtual information representing the risky situation based on the risky situation indication scenario; and a superimposing unit that superimpose the virtual information on a predetermined position in the image shot by the imaging unit.

According to the vehicle risky situation reproducing apparatus in one embodiment of the present invention configured as described above, the vehicle position and attitude calculation unit calculates the current position and the traveling direction of the vehicle. The driving action detector detects the vehicle state and the driving action of the driver during driving. The scenario generator generates a risky situation indication scenario including a content, place and timing of the risky situation occurring during driving based on a result detected by the driving action detector and a result calculated by the vehicle position and attitude calculation unit. Then, the virtual information generator generates the virtual visual information for reproducing the risky situation. The superimposing unit superimposes the virtual visual information generated as above on an image shot by the imaging unit. In addition, since the image display unit disposed to interrupt the direct visual field of the driver of the vehicle displays the image on which the generated virtual information is superimposed inside the direct visual field of the driver driving the actually traveling vehicle, the virtual risky situation with high reality can be replayed regardless of a traveling position and a traveling direction of the vehicle. Therefore, with respect to a driver with high carelessness and danger level, the risky situation that requires more attention and invites more safety awareness is selected so that the risky situation can be replayed with high reality. Thereby, a progress in the driving technique of the driver is promoted.

### Advantageous Effects

According to the vehicle risky situation reproducing apparatus according to the embodiment of the present invention, the risky situation selected based on the driving technique of the driver and the driving condition can be reproduced with a high sense of reality. Therefore, the driving technique and the enlightenment for safety awareness of the driver can be promoted.

### BRIEF DESCRIPTION OF DRAWINGS

FIG. 1 is a block diagram illustrating a schematic configuration of a vehicle risky situation reproducing apparatus according to a first example as one embodiment of the present invention.

FIG. 2A is a side view illustrating a vehicle on which the vehicle risky situation reproducing apparatus according to the first example as one embodiment of the present invention is mounted.

FIG. 2B is a top view illustrating a vehicle front portion on which the vehicle risky situation reproducing apparatus according to the first example as one embodiment of the present invention is mounted.

FIG. 3 illustrates an example of map information of a simulated town street in which the vehicle risky situation reproducing apparatus according to the first example as one embodiment of the present invention operates.

FIG. 4 illustrates one example of driving action detected by a driving action detector.

FIG. 5A illustrates one example of methods for calculating a carelessness and danger level while driving according to a duration of an inattention driving based on information stored in a driving action database.

FIG. 5B illustrates one example of calculation of the carelessness and danger level according to a vehicle speed upon entering an intersection.

FIG. 5C illustrates one example of calculation of the carelessness and danger level according to a distance between vehicles.

FIG. 6 illustrates one example of a risky situation generated in a scenario generator.

FIG. 7 illustrates one example of the risky situation reproduced in the first example as one embodiment of the present invention, and illustrates an example of reproducing a situation in which a pedestrian rushes out from behind a stopped car.

FIG. 8 illustrates one example of the risky situation reproduced in the first example as one embodiment of the present invention, and illustrates an example of reproducing a situation in which a leading vehicle slows down.

FIG. 9 illustrates one example of the risky situation reproduced in the first example as the embodiment of the present invention, and illustrates an example of reproducing a situation in which a bicycle rushes out from behind an oncoming vehicle while the vehicle turns right.

FIG. 10 is a flowchart illustrating a processing flow operated in the first example as one embodiment of the present invention.

FIG. 11 is a block diagram illustrating a schematic configuration of a vehicle risky situation reproducing apparatus according to a second example as one embodiment of the present invention.

FIG. 12 illustrates one example of a driving situation applied with the second example as one embodiment of the present invention and illustrates an example in which a driving action is compared and analyzed when route guidance information is indicated in different positions.

FIG. 13 illustrates one example of a driving situation applied with the second example as one embodiment of the present invention and illustrates an example in which an obstacle alert system mounted on the vehicle is evaluated in a situation in which a pedestrian rushes out while the vehicle turns right.

FIG. 14 is a flowchart illustrating a processing flow operated in the second example as one embodiment of the present invention.

### DESCRIPTION OF EMBODIMENTS

Hereinafter, a first example of a vehicle risky situation reproducing apparatus as one embodiment of the present invention will be described with reference to the drawings.

### First Example

In the first example, the present invention is applied to a vehicle risky situation reproducing apparatus in which a virtual risky situation generated according to driving action of a driver is reproduced on an image display unit disposed in a position interrupting the direct eyesight of the driver so as to observe the performance of the driver at that time.

### [Description of Configuration of First Example]

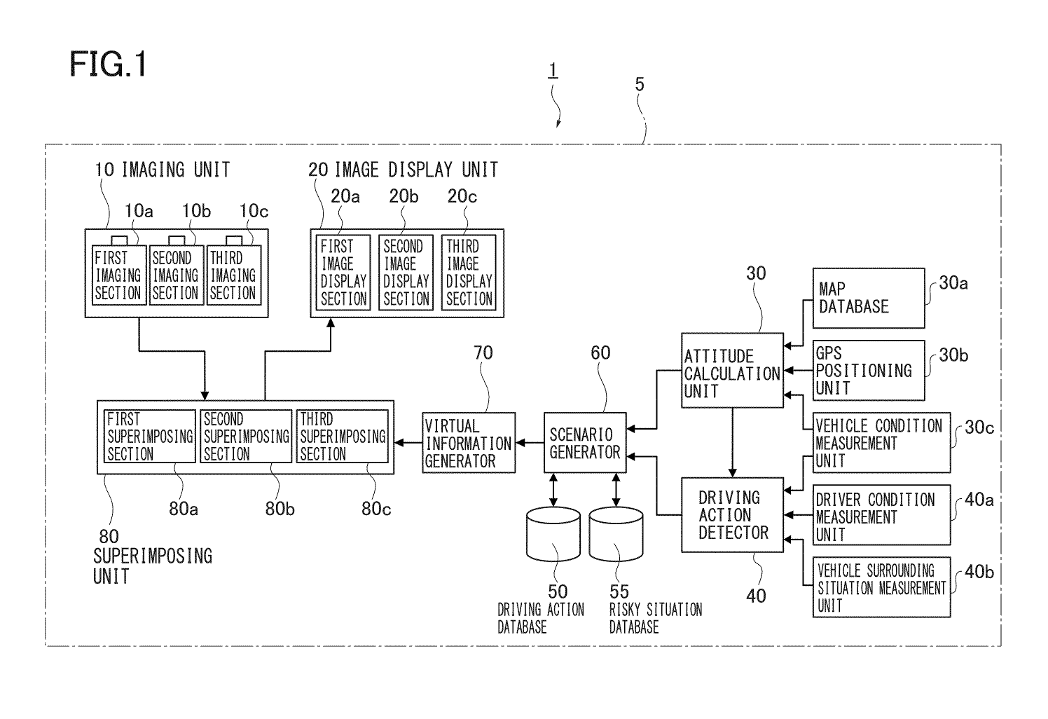

Hereinafter, the configuration of the present first example will be described with FIG. 1. A vehicle risky situation reproducing apparatus 1 according to the first example is mounted on a vehicle 5 and includes an imaging unit 10, an image display unit 20, a vehicle position and attitude calculation unit 30, a driving action detector 40, a driving action database 50, a risky situation database 55, a scenario generator 60, a virtual information generator 70, and a superimposing unit 80.

The imaging unit 10 is configured by three video cameras including a first imaging section 10a, a second imaging section 10b, and a third imaging section 10c.

The image display unit 20 is configured by three liquid crystal monitors including a first image display section 20a, a second image display section 20b, and a third image display section 20c.

The vehicle position and attitude calculation unit 30 calculates a traveling position of the vehicle 5 as current position and an attitude of the vehicle 5 as a traveling direction. The vehicle position and attitude are calculated according to a map database 30a storing a connection structure of a road on which the vehicle 5 travels and the measurement results of a GPS positioning unit 30b measuring an absolute position of the vehicle 5 and a vehicle condition measurement unit 30c measuring a traveling state of the vehicle 5 such as a vehicle speed, steering angle, lateral acceleration, longitudinal acceleration, yaw angle, roll angle, and pitch angle.

Since the vehicle condition measurement unit 30c is configured by existing sensors mounted on the vehicle 5, such as a vehicle speed sensor, steering angle sensor, acceleration sensor, and attitude angle sensor, the detailed description is omitted herein.

The driving action detector 40 detects the driving action of the driver of the vehicle 5. The driving action is detected based on the information measured by the vehicle condition measurement unit 30c that measures the vehicle speed, steering angle, lateral acceleration, longitudinal acceleration, yaw angle, roll angle, and pitch angle as the traveling state of the vehicle 5, the information measured by a driver condition measurement unit 40a that measures the condition of the driver such as a gaze direction, position of a gaze point, heartbeat, and switching operation, the information measured by a vehicle surrounding situation measurement unit 40b that measures the surrounding situation of the vehicle 5 such as a distance between the vehicle 5 and a leading vehicle and a distance between the vehicle 5 and an oncoming vehicle, and the information calculated by the vehicle position and attitude calculation unit 30.

The driver condition measurement unit 40a and the vehicle surrounding situation measurement unit 40b are configured by existing sensors. The details of these units will be described later.

The driving action database 50 includes representative information in relation to the driving action of the driver.

The risky situation database 55 includes a content of the risky situation that is supposed to be generated while the driver drives the vehicle 5.

The scenario generator 60 generates a risky situation presentation scenario including the content, generation place and generation timing of the risky situation to be presented to the driver of the vehicle 5 based on the driving action of the driver detected by the driving action detector 40, the information calculated by the vehicle position and attitude calculation unit 30, the information stored in the driving action database 50, and the information stored in the risky situation database 55.

The virtual information generator 70 generates virtual visual information which is required for presenting the risky situation based on the risky situation indication scenario generated by the scenario generator 60.

The superimposing unit 80 superimposes the virtual information generated by the virtual information generator 70 on the predetermined position of the image imaged by the imaging unit 10. Then, the superimposing unit 80 displays the image information including the superimposed virtual information on the image display unit 20. The superimposing unit 80 includes a first superimposing section 80a superimposing the generated virtual information on the image imaged by the first imaging section 10a, a second superimposing section 80b superimposing the generated virtual information on the image imaged by the second imaging section 10b, and a third superimposing section 80c superimposing the generated virtual information on the image imaged by the third imaging section 10c.

### [Description of Configuration of Vehicle]

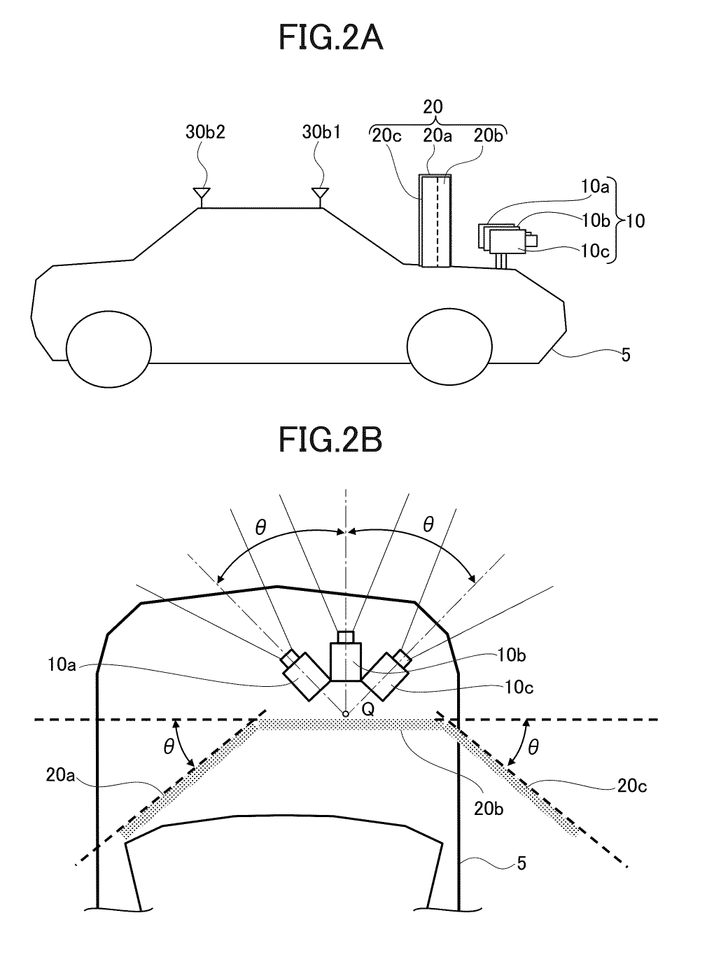

Next, with reference to FIG. 2A and FIG. 2B, the configuration of the vehicle 5 used in the first example will be described. The imaging unit 10 including the first imaging section 10a, second imaging section 10b, and third imaging section 10c, and the image display unit 20 including the first image display section 20a, second image display section 20b, and third image display section 20c are fixed to the vehicle 5, as shown in FIG. 2A and FIG. 2B.

The imaging unit 10 is configured by the same video cameras. The imaging unit 10 is disposed on the hood of the vehicle 5 to be directed to the forward of the vehicle 5, as shown in FIG. 2A and FIG. 2B.

The image display unit 20 is configured by the same rectangular liquid crystal monitors.

The imaging unit 10 is disposed on the hood of the vehicle 5 so that optical axes of the first imaging section 10a, second imaging section 10b, and third imaging section 10c have a predetermined angle θ in the horizontal direction. The imaging unit 10 is also disposed on the hood of the vehicle 5 to avoid the overlapping of the imaging ranges of the respective imaging sections. This arrangement prevents the overlapping of the same areas when each image imaged by the first imaging section 10a, second imaging section 10b and third imaging section 10c is displayed on the first image display section 20a, second image display section 20b, and third image display section 20c.

When it is difficult to dispose the first imaging section 10a, second imaging section 10b, and third imaging section 10c so as to avoid the overlapping of each imaging range, the actually imaged images may be displayed on the first image display section 20a, second image display section 20b, and third image display section 20c and the positions of the first imaging section 10a, second imaging section 10b, and third imaging section 10c may be adjusted while visually confirming the displayed images to avoid inharmoniousness in joints of the images.

A panoramic image without overlapping may be generated by synthesizing three images having partially overlapped imaging ranges and the panoramic image may be displayed on the image display unit 20.

In the image display unit 20, a shot side (vertical side) of the first image display section 20a and a short side (vertical side) of the second image display section 20b substantially contact with each other and the short side (vertical side) of the second image display section 20b and a short side (vertical side) of the third image display section 20c substantially contact with each other on the hood of the vehicle 5. Three image display surfaces configuring the image display unit 20 are disposed to be approximately vertical to the ground surface.

In addition, the image display surface of the second image display section 20b is disposed to face the driver looking the forward side while driving. The image display unit 20 is disposed so that a long side (horizontal side) of the first image display section 20a, a long side (horizontal side) of the second image display section 20b, and a long side (horizontal side) of the third image display section 20c have a predetermined angle θ.

Herein, it is desirable that the angle θ between the long side of the first image display section 20a and the long side of the second image display section 20b is nearly equal to the angle θ between the optical axes of the first imaging section 10a and the second imaging section 10b. It is desirable that the angle θ between the long side of the second image display section 20b and the long side of the third image display section 20c is nearly equal to the angle θ between the optical axes of the second imaging section 10b and the third imaging section 10c.

When a space to dispose the image display unit 20 is insufficient due to an insufficient space on the hood of the vehicle 5 or due to a restriction caused by the shape of the hood, the angle between the long side of the first image display section 20a and the long side of the second image display section 20b and the angle between the long side of the second image display section 20b and the long side of the third image display section 20c may not be set to the angle θ. In such a case, the first image display section 20a, second image display section 20b, and third image display section 20c may be disposed to have an appropriate angle while confirming the image displayed on the image display unit 20 so as to avoid the inharmoniousness in the image.

It is desirable to dispose the image display unit 20 to display the image range having a viewing angle of 55 degrees or more on the left and right sides as seen from the driver. Thereby the image imaged by the imaging unit 10 can be displayed in a driver's gaze direction even when the left and right lines of sight of the driver largely moves during turning left or right.

The driver can actually drive the vehicle 5 while watching the image imaged by the imaging and 10 disposed as described above and displayed on the image display unit 20 in real time.

In addition, a first GPS antenna 30b1 and second GPS antenna 30b2 are disposed in the lengthwise positions on the roof of the vehicle 5 to calculate the current position of the vehicle 5 and the facing direction of the vehicle 5. The function of these will be described later.

### [Description of Configuration of Traveling Path]

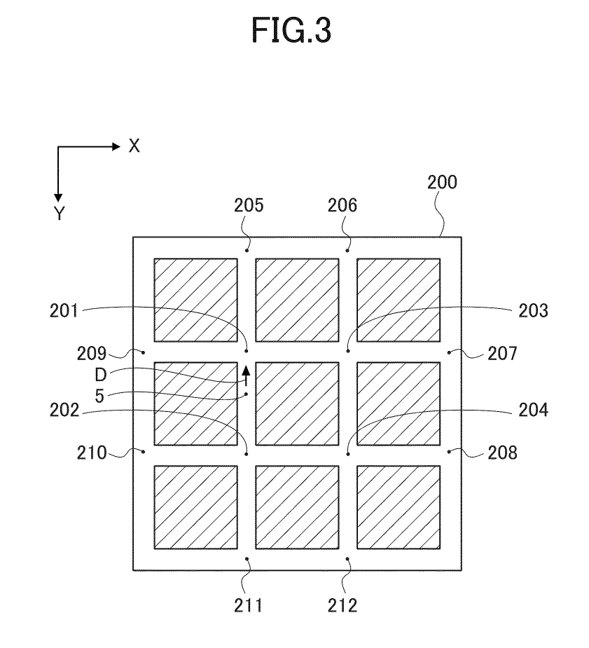

Next, a configuration of the traveling path of the vehicle 5 will be described with reference to FIG. 3. The vehicle 5 including the vehicle risky situation reproducing apparatus 1 described in the first example is a vehicle to evaluate the driving action of the driver. The vehicle 5 is permitted to travel only on a predetermined test traveling path not on a public road. An example of a simulated traveling path 200 prepared for such reason is shown in FIG. 3. In FIG. 3, the vehicle 5 travels in a direction indicated by a traveling direction D.

The simulated traveling path 200 illustrated in FIG. 3 is configured by a plurality of traveling paths extending in every directions. Crossing points of each traveling path configure intersections 201, 202, 203, and 204 and T-junctions 205, 206, 207, 208, 209, 210, 211, and 212. Each intersection and each T-junction have a traffic light where necessary.

Each traveling path is a two-lane road in which two-way traffic is allowed. Buildings are built in oblique-line areas surrounded by the traveling paths where necessary. A traffic condition of the crossing traveling path cannot be visually confirmed from each intersection and each T-junction.

In addition, previously-prepared another vehicle, pedestrians, motorcycles, and bicycles travel on the simulated traveling path 200 in addition to the vehicle 5.

In FIG. 3, the current position of the vehicle 5 is presented as a point on a two-dimensional coordinate system having a predetermined position of the simulated traveling path 200 as an origin.

### [Description of Method for Detecting Driving Action]

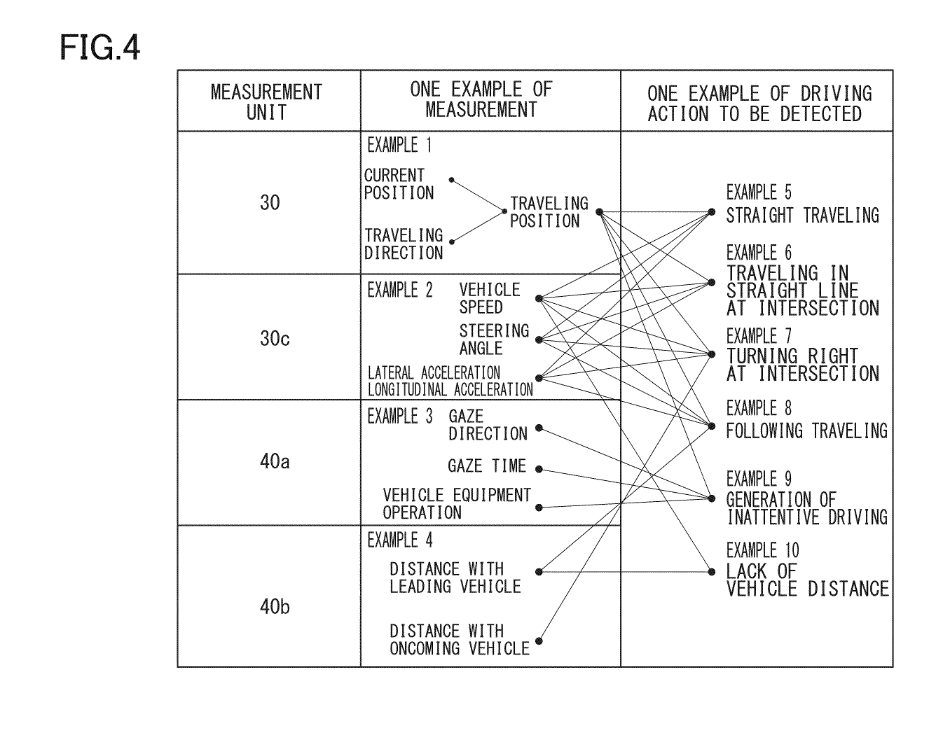

Next, with reference to FIG. 4, a method for detecting a driving action performed by the driving action detector 40 will be described. The driving action of the driver is detected based on the results calculated or measured by the vehicle position and attitude calculation unit 30, vehicle condition measurement unit 30c, driver condition measurement unit 40a, and vehicle surrounding situation measurement unit 40b which are described with reference to FIG. 1.

Herein, the vehicle position and attitude calculation unit 30 as shown in FIG. 1 calculates the current position (X, Y) and the traveling direction D of the vehicle 5 in the simulated traveling path 200.

The current position (X, Y) and the traveling direction D of the vehicle 5 are measured by GPS (Global Positioning System) positioning. The GPS positioning is employed in car navigation systems. A GPS antenna receives a signal sent from a plurality of GPS satellites and thereby, the position of the GPS antenna is measured.

In the first example, a highly accurate positioning method which is called as RTK-GPS (Real Time Kinematic GPS) positioning is used to identify the position of the vehicle 5 more accurately and measure the traveling direction of the vehicle in addition to the current position of the vehicle 5. The RTK-GPS positioning is a method using a base station disposed outside the vehicle in addition to the GPS antenna in the vehicle. The base station generates a corrective signal to correct an error in the signal sent by the GPS station, and sends the generated corrective signal to the GPS antenna in the vehicle. The GPS antenna in the vehicle receives the signal sent by the GPS satellite and the corrective signal sent by the base station. Thereby, the current position is measured accurately through the correction of the error. The current position can be specified with a few centimeters accuracy in principle.

As shown in FIG. 2A, in the first example, a first GPS antenna 30b1 and a second GPS antenna 30b2 are disposed in the vehicle 5. The RTK-GPS positioning is performed with each of the GPS antennas. The direction (traveling direction D) of the vehicle 5, in addition to the current position (X, Y) of the vehicle 5, is calculated by the front end position of the roof of the vehicle 5 measured by the first GPS antenna 30b1 and the back end position of the roof of the vehicle 5 measured by the second GPS antenna 30b2.

When the current position (X, Y) and the traveling direction D of the vehicle 5 are identified as described above, map matching between information stored in the map database 30a and the current position (X, Y) and the traveling direction D of the vehicle 5 is performed. Thereby, a traveling position of the vehicle 5 in the simulated traveling path 200 (refer to FIG. 3) is identified (refer to example 1 in FIG. 4). For example, in the example shown in FIG. 3, it is identified that the vehicle 5 travels in a straight line before the intersection 201. The identified traveling position is used as information representing the current position of the vehicle when detecting the driving action as described later.

The vehicle condition measurement unit 30c (refer to FIG. 1) detects a vehicle speed, steering angle, lateral acceleration, longitudinal acceleration, yaw angle, roll angle, and pitch angle as traveling states of vehicle 5 (refer to example 2 in FIG. 4). The detected information is used as the information representing the performance of the vehicle when detecting the driving action as described later.

The driver condition measurement unit 40a (refer to FIG. 1) measures the gaze direction and a position of the gaze point of the driver as the condition of the driver driving the vehicle 5. In addition, the driver condition measurement unit 40a detects the performance of the driver operating onboard apparatus such as a hands-free phone, car navigation system, onboard audio system, and air conditioner (refer to example 3 in FIG. 4).

The gaze direction and the position of the gaze point of the driver are measured by an apparatus for measuring eyesight disposed in the vehicle 5. The apparatus for measuring eyesight shoots the image of the driver's face and detects the position of the face and eyes of the driver from the shot image. The eyesight direction is measured based on the detected directions of the face and eyes. The gaze direction and the position of the gaze point are measured based on the temporary variation of the measured eyesight direction. Recently, such an apparatus for measuring eyesight direction is used in various situations, so the detailed description of its measurement principle is omitted.

The operation of the driver to the onboard apparatus is detected by recognizing the operation to push the switch disposed in the switch panel for operating the hands-free phone, car navigation system, onboard audio system, and air conditioner.

The information measured as described above is used for representing the physical condition of the driver while detecting the driving action as described later.

The vehicle surrounding situation measurement unit 40b (refer to FIG. 1) measures a distance between the vehicle 5 and the leading vehicle and a distance between the vehicle 5 and the oncoming vehicle as the traveling state of the vehicle 5 (refer to example 4 in FIG. 4).

More specifically, the vehicle surrounding situation measurement unit 40b includes a laser range finder or the like for measuring the vehicle distance in relation to the leading vehicle and oncoming vehicle.

As later described, the information measured as above is used for representing the conditions surrounding the vehicle while detecting the driving action.

The driving action detector 40 (refer to FIG. 1) detects the driving action of the driver based on the information of the current position, the performance of the vehicle, the condition of the driver, and the conditions surrounding the vehicle measured as above.

That is, as shown in FIG. 4, the driving action of the driver can be detected by combining the information representing the vehicle current position, information representing the performance of the vehicle, information representing the condition of the driver, and information representing the conditions surrounding the vehicle.

For example, according to the information representing the vehicle current position such that the vehicle 5 is on the straight path and the information representing the vehicle performance such that the vehicle 5 travels in a straight line at a constant speed, the condition of the vehicle 5 traveling in a straight line is detected (refer to example 5 in FIG. 4).

In addition, according to the information representing the vehicle current position such that the vehicle 5 is at an intersection and the information representing the performance of the vehicle such that the vehicle 5 travels in a straight line at the constant speed, the condition of the vehicle 5 traveling in a straight line at the intersection is detected (refer to the example 6 in FIG. 4).

In addition, according to the information representing the vehicle current position such that the vehicle 5 is at the intersection and the information representing the performance of the vehicle such that the acceleration is generated in the left side of the vehicle 5 for a predetermined duration or more, the condition of the vehicle 5 turning right at the intersection is detected (refer to example 7 in FIG. 4).

According to the information representing the vehicle current position such that the vehicle 5 is on the straight path, the information representing the performance of the vehicle 5 such that the vehicle 5 travels in a straight line at the constant speed, and the information representing the condition surrounding the vehicle 5 such that the distance between the vehicle 5 and the leading vehicle is constant, the condition of the vehicle 5 in following travel is detected (refer to example 8 in FIG. 4). Herein, when it is detected that the distance between the leading vehicle and the vehicle 5 has been at the predetermined value or less for the predetermined duration or more, the condition of the vehicle 5 having insufficient vehicle distance is detected (refer to example 10 in FIG. 4).

According to the information representing the vehicle current position such that the vehicle 5 is on the straight path, and the information representing the condition of the driver such that the gaze direction of the driver is away from the traveling direction of the path with the predetermined angle or more for the predetermined duration or more, the condition of the driver being inattention is detected (refer to example 9 in FIG. 4).

The detection examples of the action of the driver recited in FIG. 4 are the representative examples, and the driving action is not always limited to these. That is, when a relationship between the information measured or calculated by the position and attitude calculation unit 30, the vehicle condition measurement unit 30c, the driver condition measurement unit 40a, and the vehicle surrounding situation measurement unit 40b, and the driving action of the driver corresponding to the information is described, such description of the driving action of the driver can be detected with no omission.

In addition, the information measured by the vehicle condition measurement unit 30c, the driver condition measurement unit 40a, and the vehicle surrounding situation measurement unit 40b is not limited to the above-described information. That is, other than the above-described information, information that can be used in the description of the vehicle performance, the condition of the driver, and the conditions surrounding the vehicle can be used for detecting the driving action of the driver.

[Method for Calculating Carelessness and Danger Level while Driving]

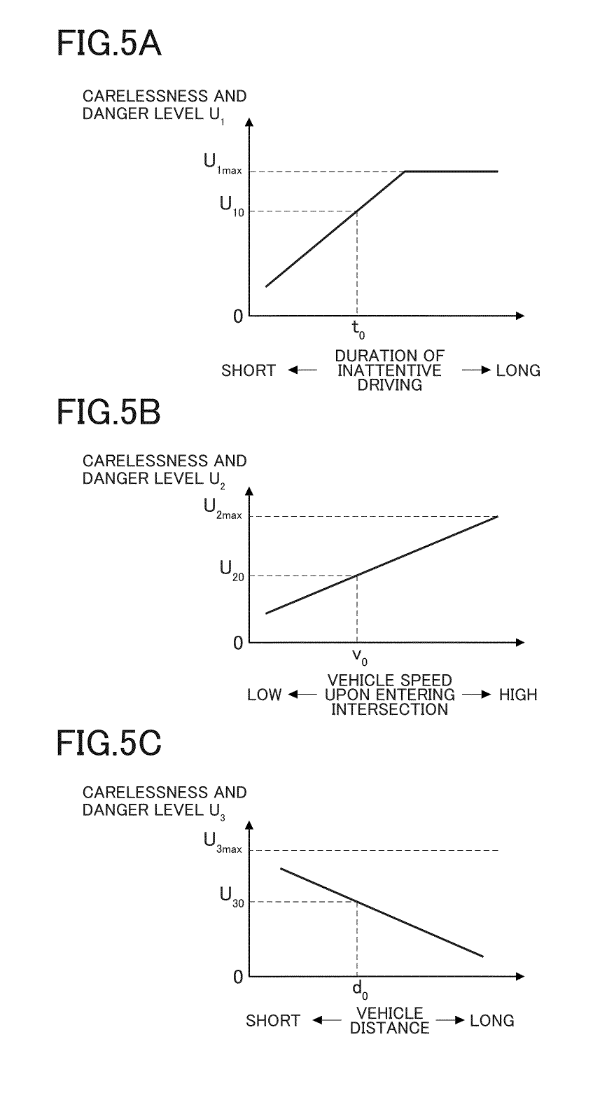

Next, with reference to FIG. 5A, FIG. 5B, and FIG. 5C, the method for calculating the carelessness level and the danger level while driving based on the driving action of the driver detected by the driving action detector 40 and the information regarding the representative driving action of the driver stored in the driving action database 50 will be described.

The careless level of the driver and the danger level of the vehicle 5 in the driving action of the driver detected by the driving action detector 40 are stored in the driving action database 50 shown in FIG. 1 with no omission.

FIG. 5A, FIG. 5B, and FIG. 5C are explanatory views describing such examples. FIG. 5A is a graph showing a carelessness and danger level U₁ when the driver of the vehicle 5 looks a side, namely, inattentive driving. The carelessness and danger level U₁ is stored in the driving action database 50.

That is, the carelessness and danger level U₁ increases as the duration of the inattentive driving increases. When the duration of inattentive driving exceeds a predetermined time, the carelessness and danger level U₁ reaches the maximum value U₁ₘₐₓ.

The carelessness and danger level U₁ shown in FIG. 5A is generated in advance based on the information obtained by evaluation experiments or known knowledge. Such information is not specific information for the driver of the vehicle 5, but the information regarding general drivers.

FIG. 5B is a graph showing a relationship between the vehicle speed when a general driver enters into an intersection and the carelessness and danger level U₂ at that moment. The carelessness and danger level U₂ is stored in the driving action database 50.

That is, the carelessness and danger level U₂ increases as the vehicle speed upon entering into the intersection increases. When the vehicle speed reaches a predetermined speed, the carelessness and danger level U₂ reaches a predetermined maximum value U₂ₘₐₓ.

The carelessness and danger level U₂ shown in FIG. 5B is also generated based on the information obtained by evaluation experiments or known knowledge.

FIG. 5C is a graph showing the carelessness and danger level U₃ relative to the vehicle distance when a general driver follows the leading vehicle in the straight path, namely, following traveling. The carelessness and danger level U₃ is stored in the driving action database 50.

That is, the carelessness and danger U₃ increases as the vehicle distance decreases. When the vehicle distance reaches a predetermined distance, the carelessness and danger level U₃ reaches the predetermined maximum value U₃ₘₐₓ.

The carelessness and danger level U₃ illustrated in FIG. 5C is also generated based on the information obtained by evaluation experiments and the known knowledge.

In the scenario generator 60 shown in FIG. 1, the carelessness and danger level U according to the driving action of the driver detected by the driving action detector 40 is read from the driving action database 50. Then, the occasional carelessness and danger level U of the driver is estimated.

The estimation of the carelessness and danger level U will be described by two specific examples.

Firstly, the situation in which the driver driving the vehicle 5 enters into the intersection at a vehicle speed v₀ while performing inattentive driving for a duration t₀ is simulated.

Herein, the carelessness and danger U₁ level by the inattentive driving is estimated as U₁₀ from the FIG. 5A.

In addition, the carelessness and danger level U₂ by the vehicle speed upon entering into the intersection is estimated as U₂₀ from the FIG. 5B.

That is, the carelessness and danger level U of the driver of the vehicle 5 is estimated by the following equation 1.

U=(U₁₀+U₂₀)/N (Equation 1)

Herein, N is a coefficient for normalization. That is, the value of the carelessness and danger level U increases as the number of risk factors (the inattentive driving duration and the vehicle speed upon entering into the intersection in the above-described example) increases. Therefore, such a coefficient is used so that the carelessness and danger level U has a predetermined range value through the predetermined normalization. The value for the coefficient N is determined by summation of the maximum values of the carelessness and danger level U for all risk factors, for example. That is, it is appropriate to be determined by the equation 2 in the case of FIG. 5A, FIG. 5B, and FIG. 5C.

N=U₁ₘₐₓ+U₂ₘₐₓ+U₃ₘₐₓ (Equation 2)

Next, a situation in which the driver driving the vehicle 5 follows the leading vehicle at a vehicle distance d₀ while performing the inattentive driving for the duration t₀ is assumed.

Herein, the carelessness and danger level U₁ by the inattentive driving is estimated as U₁₀ from FIG. 5A.

In addition, the carelessness and danger level U₃ by the vehicle distance is estimated as U₃₀ from FIG. 5C.

That is, the carelessness and danger level U of the driver of the vehicle 5 is estimated by the equation 3.

U=(U₁₀+U₃₀)/N (Equation 3)

In the above-described two examples, the carelessness and danger level U of the driver is calculated by the combination of two kinds of driving actions (risk factor) which trigger the carelessness and danger. Thus, the carelessness and danger level U of the driver may be calculated by the combination of a plurality of driving actions. The carelessness and the danger level U may be calculated by only one driving action. That is, when the continued inattentive driving is observed, the carelessness and danger level U of the driver may be calculated by only the duration of the inattentive driving.

### [Description for Method of Producing Risky Situation Indication Scenario]

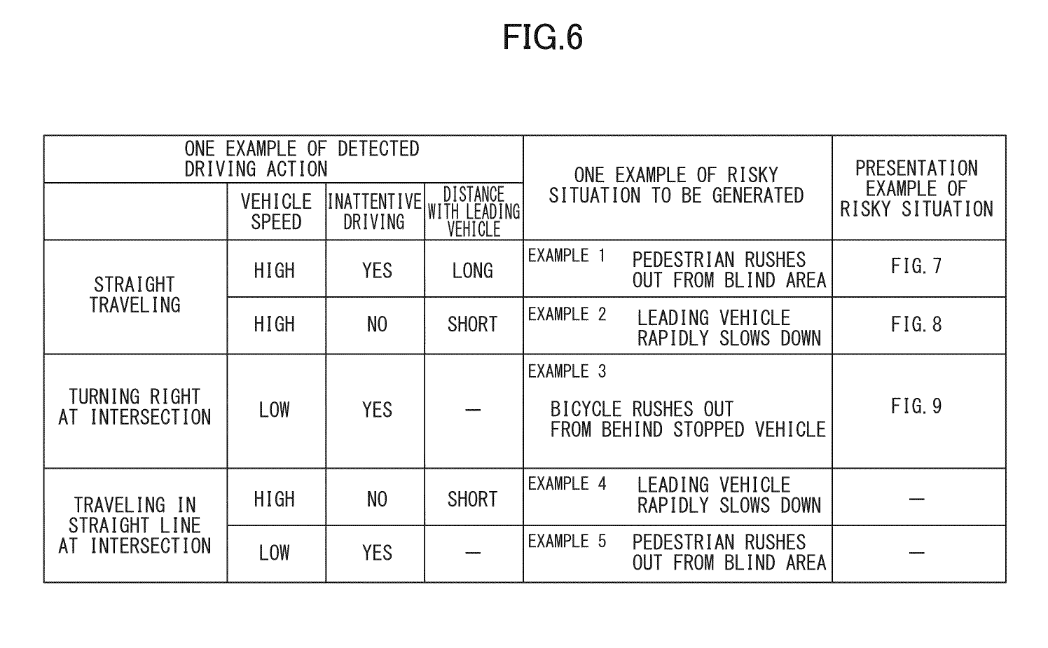

Next, the method for producing the risky situation indication scenario which is performed by the scenario generator 60 will be described with reference to FIG. 6.

FIG. 6 shows one example of the risky situation indication scenario generated based on the driving action of the driver detected by the driving action detector 40 shown in FIG. 1. Herein, the risky situation indication scenario indicates the information including the content of the risky situation, site and timing of the occurrence of the risky situation that is assumed to be generated while the driver drives the vehicle 5.

Hereinafter, an example of the risky situation indication scenarios shown in FIG. 6 will be sequentially described.

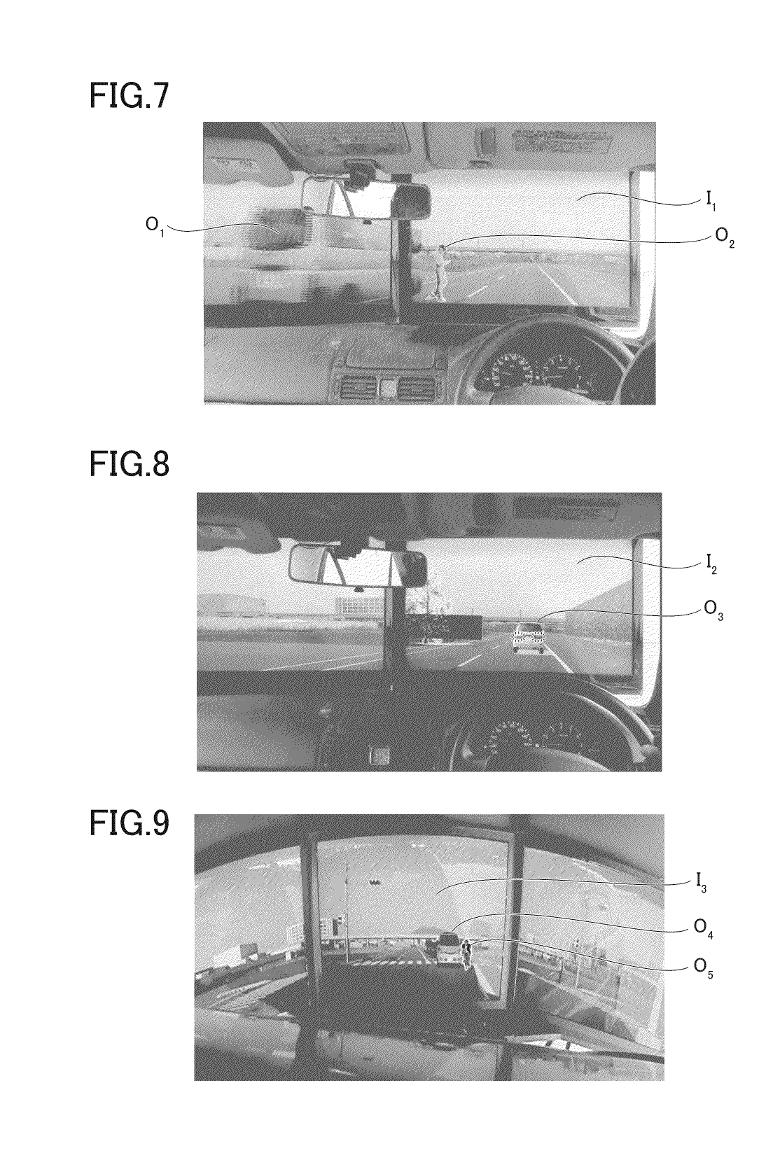

For example, it is assumed that a situation in which the vehicle 5 travels in the straight path is detected. On this occasion, when the conditions are detected such as the vehicle speed of the vehicle 5 exceeds a predetermined value for the predetermined duration, the driver performs inattentive driving, and the vehicle distance between the leading vehicle is longer than the predetermined value, a risky situation in which a pedestrian rushes our from a blind area is generated as one example of the risky situation that is assumed to occur (refer to example 1 in FIG. 6). The actual presentation method of the generated risky situation will be described later with reference to FIG. 7.

In addition, when the conditions are detected such as the vehicle 5 travels on the straight path, the vehicle speed of the vehicle 5 exceeds the predetermined value for the predetermined duration, and the vehicle distance from the leading vehicle is shorter than the predetermined value although the driver does not perform inattentive driving, a risky situation such that the leading vehicle slows down is generated as one example of the risky situation that is assumed to occur (refer to example 2 in FIG. 6). The actual method for presenting the generated risky situation will be described later with reference to FIG. 8.

Furthermore, it assumed that the situation in which the vehicle 5 turns right at the intersection is detected. On this occasion, when the inattentive driving of the driver is detected although the vehicle 5 travels at a low speed, a risky situation in which a bicycle rushes our from behind a stopped car on the oncoming vehicle lane is generated as one example of the risky situation that is assumed to occur (refer to example 3 in FIG. 6). The actual method for presenting the generated risky situation will be described later with reference to FIG. 9.

It is assumed that the situation in which the vehicle 5 travels in a straight line at the intersection is detected. On this occasion, when the conditions are detected such that the vehicle speed of the vehicle 5 exceeds the predetermined value for the predetermined duration, and the vehicle distance from the leading vehicle is shorter than the predetermined value although the driver does not perform inattentive driving, a risky situation such that the leading vehicle slows down is generated as one example of the risky situation that is assumed to occur (refer to example 4 in FIG. 6).

When it is detected that the vehicle 5 travels in a straight line at the intersection, and the driver performs the inattentive driving of the driver although the vehicle 5 travels at a low speed, a risky situation such that a pedestrian rushes out from a blind area is generated as one example of the risky situation that is assumed to occur (refer to example 5 in FIG. 6).

The risky situation indication scenario shown in FIG. 6 is just one example. That is, various kinds of risky situation that is assumed to occur can be considered according to a configuration of the simulated traveling path 200, timing (daytime or night), traffic volume, and a variation of a vehicle that is traveling. Therefore, the risky situation indication scenario generated in the scenario generator 60 (refer to FIG. 1) is generated in advance by the method shown in FIG. 6 and is stored in the risky situation database 55 (refer to FIG. 1). Then the risky situation that is assumed to occur is selected according to the driving action detected in the driving action detector 40 (refer to FIG. 1). The selected risky situation is reproduced.

### [Method for Reproducing Risky Situation Indication Scenario]

Next, the method for actually reproducing the risky situation indication scenario generated in the scenario generator 60 will be described with reference to FIG. 7, FIG. 8, and FIG. 9.

FIG. 7 shows an example of a risky situation such that a pedestrian rushes out from behind a stopped car when the vehicle 5 travels adjacent to the stopped car on the edge of the path is reproduced when the vehicle 5 is detected as traveling straight on the straight path, the vehicle speed of the vehicle 5 is detected as exceeding the predetermined value for the predetermined duration in such a case, and the inattentive driving of the driver is detected. Such an example is an example in which the risky situation shown in FIG. 6 (example 1) is actually reproduced.

In such a case, information including the risk is superimposed on the three images imaged by the imaging unit 10 by the superimposing unit 80, and the image is displayed on the image display unit 20.

In detail, a situation in which a pedestrian O₂ rushes out from behind a stopped car O₁ when the vehicle 5 travels adjacent to the stopped car O₁ is resented in an image I₁ displayed on the image display unit 20.

The image of the pedestrian O₂ is generated by cutting the image of the pedestrian only from the image generated by Computer Graphics (CG) or a real video image. Then, the image of the pedestrian O₂ is superimposed on the image I₁ at the timing in which the pedestrian O₂ cut across the front of the vehicle when the vehicle 5 reaches on the side of the stopped car O₁. The timing for displaying image I₁ on which the image of the pedestrian O₂ is superimposed is set based on the vehicle speed of the vehicle 5.

While the image I₁ on which the pedestrian O₂ is superimposed is displayed, when the driver of the vehicle 5 realizes the rushing out of the pedestrian O₂, the driver decreases the speed of the vehicle 5 or operates a steering so as to avoid the pedestrian O₂. However, when the driver does not realize the rushing out of the pedestrian O₂ or necessary avoidance action is delayed, the collision of the vehicle 5 and the pedestrian O₂ occurs.

FIG. 8 shows an example reproducing a risky situation in which the leading vehicle O₃ slows down at a deceleration of 0.3 G for example, when the vehicle 5 is detected as traveling on the straight path, the vehicle speed of the vehicle 5 at the moment is detected as exceeding the predetermined value for the predetermined duration, and the vehicle distance from the leading vehicle O₃ is shorter than the predetermined distance. Such an example is an example actually reproducing the risky situation shown in example 2 in FIG. 6.

On this occasion, when the driver of the vehicle 5 realizes the decrease of the speed of the leading vehicle O₃, the driver decreases the speed of the vehicle 5 or operates a steering so as to avoid the leading vehicle O₃. However, when the operator does not realize the decrease of the speed of the leading vehicle O₃ or necessary avoidance action is delayed, the collision of the vehicle 5 and the leading vehicle O₃ occurs.

FIG. 9 shows an example reproducing a risky situation such that a bicycle O₅ generated by CG comes from behind a stopped car O₄ which falls way to the vehicle 5 when the vehicle 5 is detected as turning right at the intersection and the inattentive driving of the driver is detected. The example actually reproduces the risky situation shown in example 3 in FIG. 6.

On this occasion, the driver of the vehicle 5 realizes the appearance of the bicycle O₅, and decreases the speed of the vehicle 5. However, when the appearance of the bicycle O₅ is not realized or necessary avoidance action is delayed, the collision between the vehicle 5 and the bicycle O₅ occurs.

As described above, the risky situation according to the risky situation indication scenario generated by the scenario generator 60 (refer to FIG. 1) is generated and displayed on the image display unit 20.

### [Description of Flow of Process in First Example]

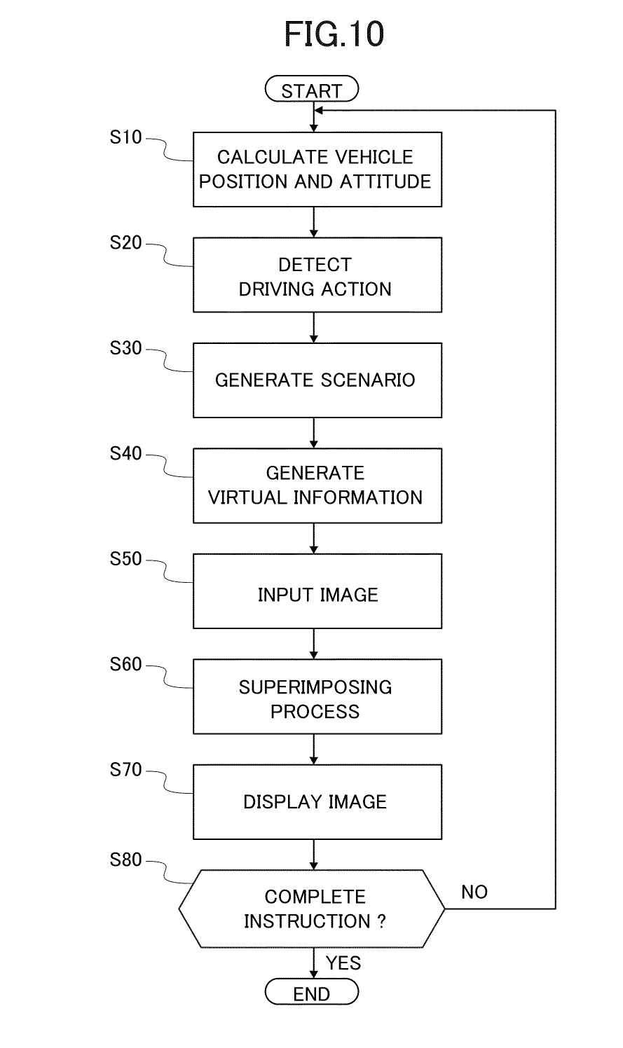

Next, a flow of a process in the first example will be described with reference to FIG. 10. A traveling path in the simulated traveling path 200 is presented to the driver as needed by the car navigation system disposed in the vehicle 5.

In the step S10, the position and attitude of the vehicle 5 are calculated by the position and attitude calculation unit 30.

In the step S20, the action of the driver of the vehicle 5 is detected by the driving action detector 40.

In the step S30, the risky situation indication scenario is generated by the scenario generator 60.

In the step S40, the visual information for reproducing the generated risky situation indication scenario is generated by the virtual information generator 70 (for example, pedestrian O₂ in FIG. 7, leading vehicle O₃ in FIG. 8, and bicycle O₅ in FIG. 9).

In the step S50, the image in front of the vehicle 5 is shot by the imaging unit 10.

In the step S60, the superimposing process is performed by the superimposing unit 80 so as to superimpose the virtual information generated by the virtual information generator 70 on the image in front of the vehicle 5 shot by the imaging unit 10. The position to be superimposed is calculated according to the position and attitude of the vehicle 5.

In the step S70, the image on which the virtual information is superimposed is displayed on the image display unit 20.

In the step S80, when the traveling on a predetermined traveling path is completed, the completion of the evaluation experiment is informed to the driver by the car navigation system disposed in the vehicle 5, for example. The driver finishes driving of the vehicle 5 after confirming the completion announcement. When the driving is continued, the step goes back to the step S10 and each step is repeated in series.

Next, a second example as one embodiment of the vehicle risky situation reproducing apparatus according to the present invention will be described with reference to the figures.

### Second Example

### Second Example

The second example is an example which applies the present invention to a vehicle risky situation reproducing apparatus. When the evaluation experiment is performed with the vehicle risky situation reproducing apparatus by reproducing the risky situation that is assumed to occur according to the driving action of the driver, the vehicle risky situation reproducing apparatus stores the content of the reproduced risky situation and the driving action of the driver at the moment and the vehicle risky situation reproducing apparatus reproduces the stored information after the evaluation experiment is completed.

### [Description for Configuration of Second Example]

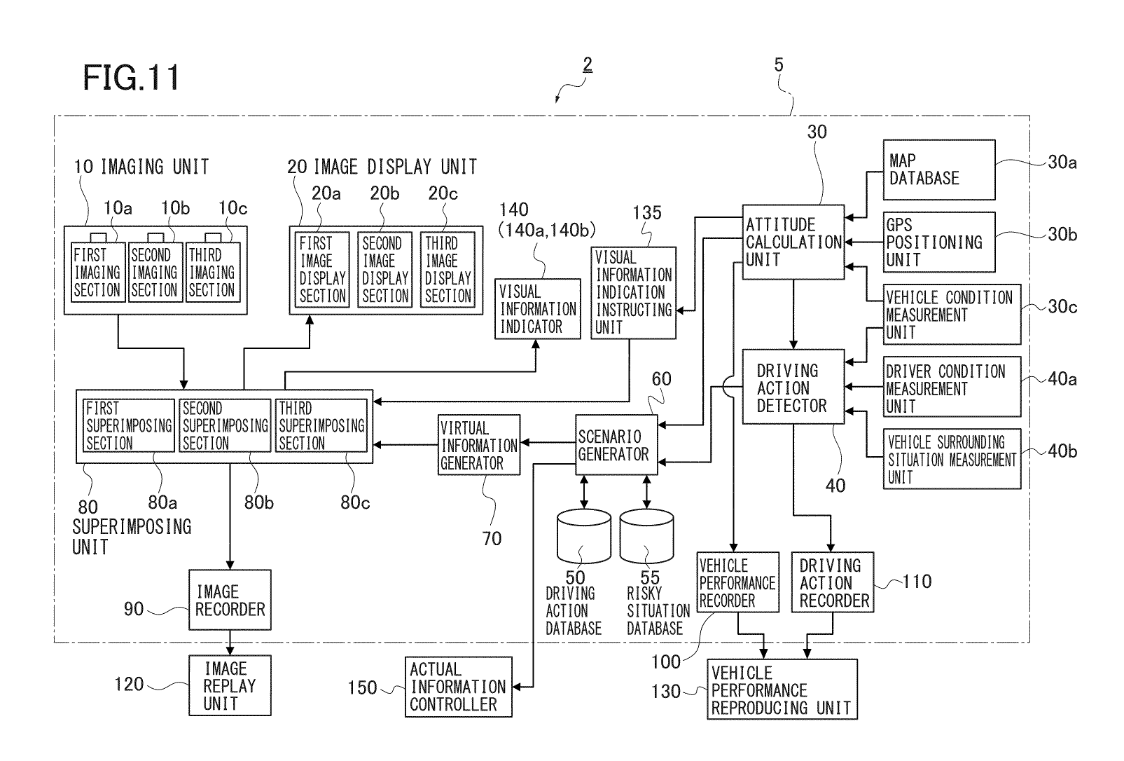

A configuration of the second example will be described with reference to FIG. 11. A vehicle risky situation reproducing apparatus 2 includes an imaging unit 10, image display unit 20, position and attitude calculation unit 30, driving action detector 40, driving action database 50, risky situation database 55, scenario generator 60, virtual information generator 70, superimposing unit 80, image recorder 90, vehicle performance recorder 100, driving action recorder 110, visual information indication instructing unit 135, visual information indicator 140 (first visual information indicator 140a and second visual information indicator 140b) which are disposed in the vehicle 5. The vehicle risky situation reproducing apparatus 2 includes an image replay unit 120, driving action and vehicle performance reproducing unit 130, and actual information controller 150 which are disposed in the other place than the vehicle 5.

Herein, a configuration element having a reference number same as that of the configuration element described in the first example has the same function as described in the first example, so the detailed description of thereof is omitted. Hereinafter, a function of the configuration element that is not included in the first example will be described.

The image recorder 90 stores the image displayed on the image display unit 20. On this occasion, the virtual information which is generated by the virtual information generator 70 and superimposed by the superimposing unit 80 is also stored. When the image is stored, the time information at the moment is also stored.

The vehicle performance recorder 100 stores the vehicle position and vehicle attitude calculated by the vehicle position and attitude calculation unit 30. Upon storing, the time information in which the vehicle position and vehicle attitude are calculated is also stored.

The driving action recorder 110 stores the driving action of the driver of the vehicle 5 which is detected by the driving action detector 40. Upon storing, the time information in which the driving action is detected is also stored.

The image replay unit 120 replays the image stored in the image recorder 90. Herein, the image replay unit 120 is disposed in a place other than the vehicle 5 such as a laboratory, and includes a display having the same configuration as the image display unit 20. The same image shown to the driver of the vehicle 5 is replayed on the image replay unit 120.

The driving action and vehicle performance reproducing unit 130 reproduces the information stored in the vehicle performance recorder 100 and the driving action recorder 110 through visualization. The driving action and vehicle performance reproducing unit 130 is disposed in a place other than the vehicle 5 such as a laboratory, and reproduces the information stored in the vehicle performance recorder 100 and the driving action recorder 110 by graphing or scoring.

The visual information indication instructing unit 135 sends a command to a later described visual information indicator 140 so as to display the visual information.

The visual information indicator 140 is configured by an 8-inch liquid crystal display which displays the predetermined visual information to the driver of the vehicle 5, for example. Then, according to the command from the visual information indication instructing unit 135, the visual information indicator 140 is used for evaluating a benefit of the indication position or the indication content when various types of visual information is presented to the driver driving the vehicle 5. The two different visual information indicators 140 are used in the second example as described later. The visual information indicator 140 includes a first visual information indicator 140a and a second visual information indicator 140b as the two different visual information indicators.

The visual information indicator 140 is configured so that the liquid crystal display can be disposed in each different position of a plurality of predetermined positions on the vehicle 5.

In addition, the visual information indicator 140 may be configured as a virtual display section displayed in the image displayed by the image display unit 20, not an actual display such as the liquid crystal display. Thereby, a display device which indicates an image which cannot be reproduced by an actual display image, such as a head-up display, can be used for simulation.

The actual information controller 150 is used for evaluating an effect of various types of systems for safety precaution disposed in the vehicle 5. More specifically, the actual information controller 150 controls a motion of real information configuring the actual risky situation by indicating the real information in the simulated traveling path 200 (refer to FIG. 3) in which the vehicle 5 is traveling, according to the risky situation indication scenario generated by the scenario generator 60. As the real information, a balloon indicating an imitated pedestrian is used for example.

By using the actual information controller 150, an effect of an alert from an alert system for an obstacle can be evaluated. For example, by the function of the actual information controller 150, the balloon as the real information is moved to just in front of the vehicle 5 having the alert system for an obstacle. The alert system for an obstacle observes the driver's action by detecting the balloon when the driver takes an actual motion. The description of the example will be described later as the second specific example for utilization.

### [Description for First Specific Utilization Example of Second Example]

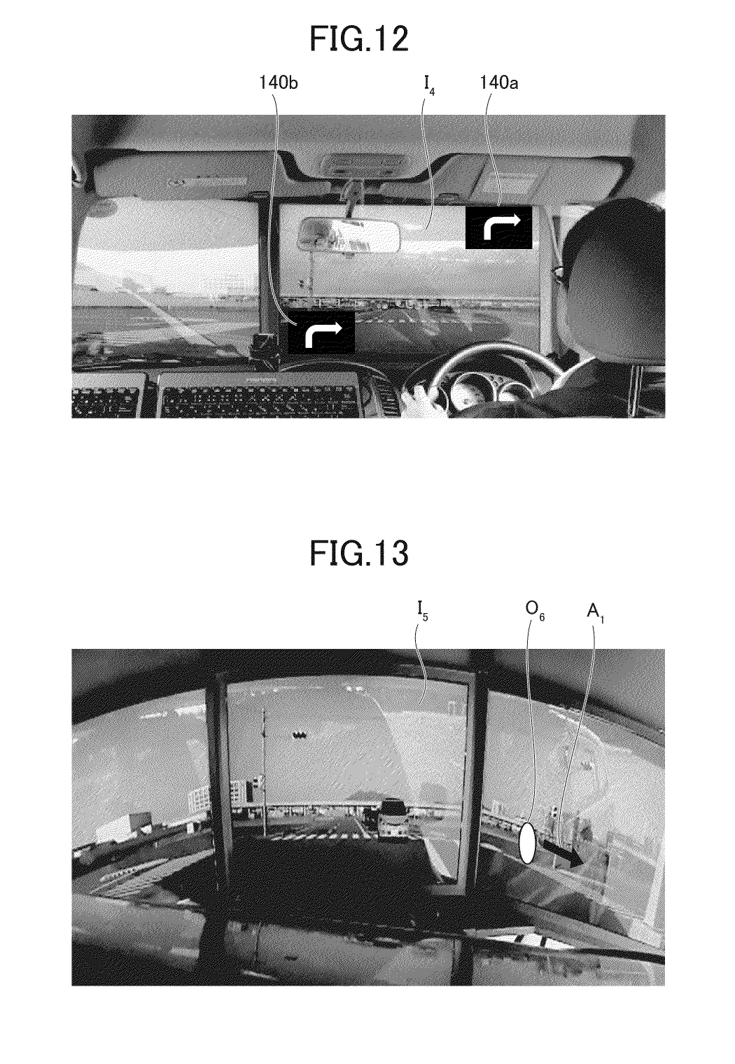

Next, a first specific utilization example of the second example will be described with reference to FIG. 12.

FIG. 12 shows an example using the vehicle risky situation reproducing apparatus in the HMI (Human Machine Interface) evaluation for determining the display position of route guidance information.

Hereinafter, the configuration of the equipment shown in FIG. 11 will be described in detail. FIG. 12 shows an example in which a first visual information indicator 140a and a second visual information indicator 140b are included in an image I₄ displayed on the image display unit 20, and the driving action of the driver is observed when the route guidance information is indicated in one of the first visual information indicator 140a and the second visual information indicator 140b.

The first visual information indicator 140a is disposed on the upper side in front of the driver. The second visual information indicator 140b is disposed around the center of the upper end portion of the instrument panel of the vehicle.

For the description, an arrow for instructing right turn is indicated on both of the first visual information indicator 140a and the second visual information indicator 140b. However, only one of the first visual information indicator 140a and the second visual information indicator 140b is actually indicated.

The first visual information indicator 140a and the second visual information indicator 140b may be configured by a liquid crystal display. Specifically, since the first visual information indicator 140a is assumed to use so-called Head-Up Display (HUD) for indicating information on a windshield of the vehicle 5, it is appropriate to indicate information so that it can be seen as being included in the windshield. Therefore, in the present second example, the first visual information indicator 140a and the second visual information indicator 140b are configured as a virtual indicator by superimposing the information to the image I₄ by the superimposing unit 80.

When the position and attitude calculation unit 30 detects the fact that the vehicle 5 is before the intersection with the predetermined distance, the first visual information indicator 140a and the second visual information indicator 140b indicate the route guidance information according to the command for indicating the route guidance information (visual information) output from the visual information indication instructing unit 135.

The image I₄ indicated to the driver is stored in the image recorder 90. The performance of the vehicle is stored in the vehicle performance recorder 100, and the behavior of the driver is stored in the driving action recorder 110.

After the evaluation, the image I₄ stored in the image recorder 90 is reproduced by the image replay unit 120. The performance of the vehicle 5 stored in the vehicle performance recorder 100 and the driving action of the driver stored in the driving action recorder 110 are reproduced by the vehicle performance reproducing unit 130.

The performance of the vehicle 5 and the driving action of the driver are compared between when the route guidance information is indicated in the first visual information indicator 140a and when the route guidance information is indicated in the second visual information. Thereby, the indication position of the route guidance information is evaluated.

Specifically, the position of the gaze point measured by the driver condition measurement unit 40a and stored in the driving action recorder 110 is reproduced by the driving action and vehicle performance reproducing unit 130. Then, according to a movement pattern of the reproduced gaze point position, for example, a difference in the movement pattern of the gaze point relative to the indication position of the route guidance information can be evaluated. Thereby, the more appropriate indication position of the route guidance information can be determined.

The carelessness and danger level U of the driver is calculated by the driving action and vehicle performance reproducing unit 130 according to the driving action of the driver detected by the driving action detector 40. Then, a difference in the carelessness and danger level U of the driver relative to the indication position of the route guidance information is evaluated quantitatively. Thereby, the appropriate indication position of the information can be determined.

In addition, not only the indication position of the route guidance information but also a timing of the indication of the route guidance information is changed so that the appropriate timing of the indication of the route guidance can be determined.

As described above, effectivity and adequacy upon indicating the information to the driver by the car navigation system or the like can be evaluated with the use of the vehicle risky situation reproducing apparatus 2. The requirements for Human Machin Interface (HMI) such as the indication position and the indication method of the information on the above moment can be determined efficiently.

In the second example, the evaluation is performed by reproducing the information stored in the image recorder 90, vehicle performance recorder 100, and driving action recorder 110 by the image replay unit 120, and the driving action and vehicle performance reproducing unit 130 which are disposed on the place other than the vehicle 5. However, the image replay unit 120 and the driving action and vehicle performance reproducing unit 130 can be disposed in the vehicle 5 to perform the evaluation in the vehicle 5.

In the second example, the visual information is indicated in the visual information indicator 140 to perform HMI evaluation. However, the HMI evaluation can be performed by providing a sound information indicator instead of the visual information indicator 140, or by providing a sound information indicator in addition to the visual information indicator 140.

Although not shown in FIG. 11, the risky situation can be reproduced by the image replay unit 120 on a board without actual traveling of the vehicle 5, by inputting the information stored in the map database 30a and virtual traveling information of the vehicle 5. Herein, the image replay unit 120 can be used for confirming that the information to be indicated on the visual information indicator 140 is reliably indicated before actually traveling the vehicle 5.

### [Description for Second Specific Utilization Example of Second Example]

Next, the second specific utilization example of the second example will be described with reference to the FIG. 13.

FIG. 13 shows an example in which the vehicle risky situation reproducing apparatus 2 is used as a tool for evaluating the driver's action when an alert system for an obstacle, which is one of the systems for safety precaution, sends alert informing presence of an obstacle, and when the driver of the vehicle 5 executes the avoiding performance of the obstacle upon realizing it.

The details shown in FIG. 13 will be described specifically with reference to the configuration of the equipment shown in FIG. 11. FIG. 13 shows an example in which a balloon O₆ which represents a pedestrian moving in the direction of the arrow A1 is indicated in the image I₅ on the image display unit 20. Herein, the driving action of the driver when the not-shown alert system for an obstacle outputs an alert is observed.

The motion of the balloon O₆ is controlled by the actual information controller 150. Specifically, the balloon O₆ is provided in advance around a predetermined intersection in the simulated traveling path 200 (refer to FIG. 3) to communicate with the actual information controller 150. Thereby the balloon O₆ is informed that the vehicle 5 approaches the predetermined intersection. Then, the balloon O₆ is moved along a rail disposed along the cross-walk at the timing in which the vehicle 5 starts turning right.

In this case, the obstacle sensor of the alert system for an obstacle disposed in the vehicle 5 detects the balloon O₆ and outputs the predetermined alert (hereinafter, referred to as obstacle alert) which represents the presence of the obstacle.

Thereby, the driver of the vehicle 5 realizes the presence of the obstacle by the alert, and executes a driving action to avoid the balloon O₆ by decreasing a speed or by steering.

During a series of above described flow, the image I₅ represented to the driver is stored in the image recorder 90, the performance of the vehicle 5 is stored in the vehicle performance recorder 100, and the driver's action is stored in the driving action recorder 110.

When the evaluation is completed, the image I₅ stored in the image recorder 90 is replayed in the image replay unit 120, the performance of the vehicle 5 stored in the vehicle performance recorder 100 and the driving action of the driver stored in the driving action recorder 110 are reproduced by the driving action and vehicle performance reproducing unit 130.

By analyzing the performance of the vehicle 5 and the driving action driver when the alert system for an obstacle outputs the alert, the validity of the method for outputting the alert can be evaluated.

Specifically, for example, by analyzing the position of the gaze point stored in the driving action recorder 110, it can be analyzed how many times is required for the driver to realize the presence of the balloon O₆ from the output of the obstacle alert.

In addition, for example, by analyzing the traveling locus of the vehicle 5 in the performance of the vehicle 5 stored in the vehicle performance recorder 100, the appropriateness of the avoiding action after the output of the obstacle alert can be analyzed. From the other necessary viewpoint, the stored image I₅, the stored performance of the vehicle 5 and the stored driving action of the driver can be analyzed.

As described above, by using the vehicle risky situation reproducing apparatus 2, the effectiveness of the system for safety precaution can be evaluated when the system is newly constructed.

Herein, although the balloon O₆ represents the pedestrian, an image processing unit for detecting the position of the balloon O₆ from the image imaged by the imaging unit 10 may be disposed in addition to the configuration shown in FIG. 11 when the representation of the balloon O₆ is not realistic. In this case, a CG image of the pedestrian generated by the virtual information generator 70 is superimposed by the superimposing unit 80, and the image on which the pedestrian is superimposed is displayed on the image display unit 20, so that the image I₅ may be indicated with high reality.

### [Description for Process Flow of Second Example]

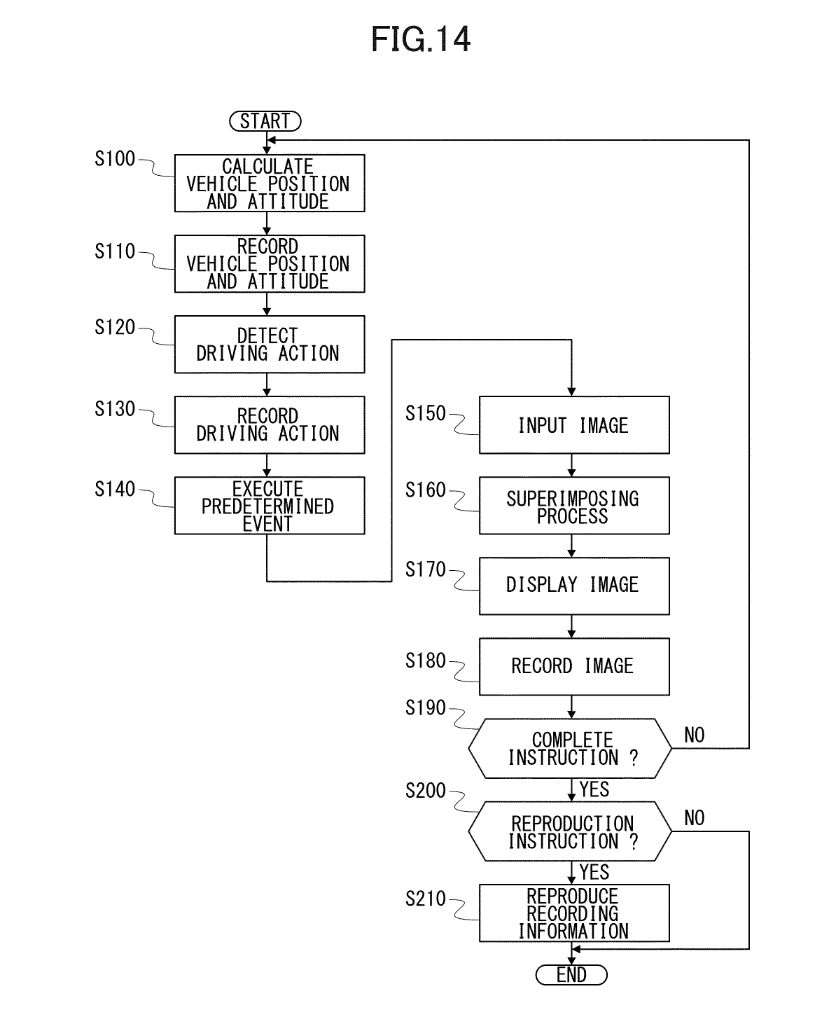

Next, the process flow of the second example will be described with reference to FIG. 14. Herein, the traveling route in the simulated traveling path 200 is indicated to the driver by the car navigation system mounted in the vehicle 5 as needed.

In the step S100, the position and attitude of the vehicle 5 are calculated by the vehicle position and attitude calculation unit 30.

In the step S110, the vehicle position and vehicle attitude calculated by the vehicle position and attitude calculation unit 30 are stored by the vehicle performance recorder 100.

In the step S120, the action of the driver of the vehicle 5 is detected by the driving action detector 40.

In the step S130, the driving action of the driver of the vehicle 5 detected by the driving action detector 40 is stored by the driving action recorder 110.

In the step S140, a predetermined event which is set in advance is executed. That is, the visual information indicator 140 indicates predetermined visual information at a predetermined timing or the alert system for an obstacle mounted on the vehicle 5 outputs an alert at a predetermined timing.

In the step S150, the image in front of the vehicle 5 is shot by the imaging unit 10.

In the step S160, the virtual information generated by the virtual information generator 70 is superimposed on the image in front of the vehicle 5 imaged by the imaging unit 10 by the superimposing unit 80. The position to be imposed is calculated according to the position and attitude of the vehicle 5.

In the step S170, the image on which the virtual information is superimposed is indicated by the image display unit 20.

In the step S180, the image on which the virtual information generated by the superimposing unit 80 is superimposed is stored by the image recorder 90.

In the step S190, when the traveling of the vehicle 5 on a predetermined traveling route is completed, the car navigation system mounted on the vehicle 5 informs the completion of the evaluation experiment to the driver.

The driver stops driving at a predetermined position after confirming the completion direction. The step goes back to the step S100 and each step is repeated in series when the traveling is continued.

In the step S200, after the recording of the information is completed, the information stored in the image recorder 90, vehicle performance recorder 100, and driving action recorder 110 is moved to the image replay unit 120 and the driving action and vehicle performance reproducing unit 130 as needed. When the replay of the stored information is instructed, the step goes to the step S210. When the replay instruction is not sent, the process shown in FIG. 14 is completed.

In the step S210, the image stored in the image recorder 90, the performance of the vehicle 5 stored in the vehicle performance recorder 100, and the driving action of the driver stored in the driving action recorder 110 are reproduced by the image replay unit 120 and the driving action and vehicle performance reproducing unit 130. Thus, the necessary analysis for the reproduced information is performed.

It is described that the image replay unit 120 and the driving action and vehicle performance reproducing unit 130 are disposed in the place other than the vehicle 5, such as a laboratory. However, the image replay unit 120 and the driving action and vehicle performance reproducing unit 130 can be disposed in the vehicle 5.

As described above, according to the vehicle risky situation reproducing apparatus 1 of the first example, the vehicle position and attitude calculation unit 30 calculates the current position (X, Y) and the traveling direction D of the vehicle 5, and the driving action detector 40 detects the action of the driver driving the vehicle 5 and detects the condition of the vehicle 5. Then, the scenario generator 60 generates the risky situation indication scenario including the content, place of occurrence, and timing of occurrence of the risky situation to be generated while the driver drives the vehicle 5 based on the detection result of the driving action detector 40 and the calculation result of the vehicle position and attitude calculation unit 30.

In addition, the virtual information generator 70 generates the visual virtual information representing the risky situation. The superimposing unit 80 superimposes the generated visual virtual information on the image shot by the imaging unit 10.

Then, the image display unit 20 disposed to interrupt the direct visual field of the driver of the vehicle 5 indicates the image on which the generated virtual information is superimposed inside the driver's direct visual field. Thereby, the virtual risky situation can be reproduced in the direct visual field of the driver driving the actual vehicle with high reality regardless of the traveling position or the traveling direction of the vehicle 5. Therefore, the risky situation which requires more attention and safety awareness is selected when the carelessness and dangerous level of the driver is high, and the risky situation can be reproduced with high reality.

In addition, according to the vehicle risky situation reproducing apparatus 1 of the first example, the driving action detector 40 detects the driving action of the driver according to the information representing the position and attitude of the vehicle 5, the information representing the physical condition of the driver, and the information representing the surrounding condition of the vehicle 5. Therefore, when the current position (X, Y) of the vehicle, the traveling direction D and the conditions surrounding the vehicle are obtained, the driving action of the driver can be detected. Thereby, the driving action which may occur can be estimated at certain extent. Accordingly, the driving action of the driver can be detected efficiently and accurately.

The vehicle risky situation reproducing apparatus 1 of the first example includes the driving action database 50 storing the content of the careless action or dangerous action during driving and the information about the vehicle position and attitude, the information about the physical condition of the driver, the information about the performance of the vehicle, and the information about the conditions surrounding the vehicle. Then, the scenario generator 60 calculates the carelessness and danger level U of the driver according to the detection result of the driving action detector 40, the calculation result of the position and attitude calculation unit 30 and the content of the driving action database 50 to generate the risky situation indication scenario according to the carelessness and danger level U. Accordingly, the risky situation corresponding to the driving technique of the driver can be indicated. Therefore, the indication frequency of the risky situation can be increased to an inexperienced driver having a high carelessness and danger level U or the unaccustomed risky situation can be reproduced repeatedly to such a driver. On the other hand, the indication frequency of the risky situation can be decreased to an experienced driver having a low carelessness and danger level or the risky situation which requires more attention can be indicated to such a driver. As described, educational effectiveness for the improvement of driving technique can be realized with high reality.

In the vehicle risky situation reproducing apparatus 2 of the second example, the driving action recorder 110 stores the driving action of the driver detected by the driving action detector 40, and the vehicle performance recorder 100 stores the current position (X,Y) and the traveling direction D of the vehicle 5 calculated by the position and attitude calculation unit 30. In addition, the image recorder 90 stores the image indicated on the image display unit 20 including the virtual information, the image replay unit 120 replays the image stored on the image recorder 90, and the driving action and vehicle performance reproducing unit 130 reproduces the information stored by the driving action recorder 110 and the information stored by the vehicle performance recorder 100. Therefore, the risky situation indicated to the driver and the driving action of the driver at the moment can be reproduced easily after finishing the driving. Since the appropriate and necessary analysis can be executed relative to the reproduced driving action, the driving action can be analyzed efficiently.

According to the vehicle risky situation reproducing apparatus 2 of the second example, the visual information indicator 140 indicates the visual information corresponding to the driving execution in the predetermined position in the image display unit 20 when the visual information indication instructing unit 135 instructs the indication of the visual information. Therefore, various indication patterns of the visual information can be reproduced and indicated to the driver easily. In addition, the actual information controller 150 controls the motion of the real information under the actual environment. Thus, a new system for safety precaution is mounted on the vehicle 5. The system for safety precaution can be operated actually according to the motion of the real information. The risky situation including the real information can be reproduced with high reality during actual traveling of the vehicle since the motion controlled real information is imaged by the imaging unit 10 and indicated on the image display unit 20.

The visual information indication scene and the risky situation which are reproduced as above are stored by the vehicle performance recorder 100 and the driving action recorder 110, and image replay unit 120 and the driving action and vehicle performance reproducing unit 130 can reproduce such information and the situation. Therefore, the information corresponding to the driving action of the driver of the vehicle 5 upon the visual information indication scene and the risky situation which are reproduced with high reality can be obtained.

As the second example, the example in which the appropriation of the indication position of the route guidance information is evaluated and the example in which the efficiency of the alert system for an obstacle is evaluated are explained. However, the method for using the vehicle risky situation reproducing apparatus 2 is not limited thereto.

That is, according to the vehicle risky situation reproducing apparatus 2 in the second example, the image indicated to the driver, vehicle position and vehicle attitude, and the driving action can be stored and reproduced when the risky situation is reproduced. Therefore, for example, the driving action performed by different drivers on the same position can be comparatively evaluated by quantification.

Accordingly, the comparative evaluation whether the risky situation is reproduced or not, and the evaluation of the learning effect by repeatedly indicating the same risky situation can be executed easily. Therefore, the vehicle risky situation reproducing apparatus 2 can be applied widely for the driver education at a driving school and the confirmation of the effect thereof, the confirmation of the effect of the measure to prevent a road accident, and the confirmation of the effect of the measure to improve the safety of the incidental equipment of the road, for example.

The vehicle risky situation reproducing apparatus 2 can indicate any virtual information generated by the virtual information generator 70 to the image display unit 20 at any timing. Therefore, the vehicle risky situation reproducing apparatus 2 can be used as a research and development assistant tool performing detection of the hypothesis when the analysis of the driver's visual sense property or the analysis of the driver's action is executed.

The balloon O₆ is used in the vehicle risky situation reproducing apparatus 2 of the second example for representing the real information; however, it is not limited to the balloon. A dummy doll or a dummy target can be used instead.

Although the embodiment of the present invention has been described in terms of exemplary referring to the accompanying drawings, the present invention is not limited to the configuration in the embodiments. The variations or modification in design may be made in the embodiments without departing from the scope of the present invention.

### CROSS-REFERENCE TO RELATED APPLICATION

The present application is based on and claims priority from Japanese Patent Application No. 2013-049067, filed on Mar. 12, 2013, the disclosure of which is hereby incorporated by reference in its entirety.

### REFERENCE SIGNS LIST

1 Vehicle risky situation reproducing apparatus
5 Vehicle
10 Imaging unit
20 Image display unit
30 Vehicle position and attitude calculation unit
30a Map database
30b GPS Positioning part
30c Vehicle condition measurement unit
40 Driving action detector
40a Driver condition measurement unit
40b Vehicle surrounding situation measurement unit
50 Driving action database
55 Risky situation database
60 Scenario generator
70 Virtual information generator
80 Superimposing unit

1. A vehicle risky situation reproducing apparatus comprising:
an imaging unit mounted on an actually traveling vehicle to shoot an image in a traveling direction of the vehicle;
an image display unit disposed to interrupt a direct visual field of a driver of the vehicle to display the image shot by the imaging unit;
a vehicle position and attitude calculation unit that calculates a present position and a traveling direction of the vehicle;
a driving action detector that detects a driving action of the driver while driving the vehicle;
a scenario generator that generates a risky situation indication scenario including a content, a position and a timing of a risky situation occurring while the driver drives the vehicle based on a detection result of the driving action detector and a calculation result of the vehicle position and attitude calculation unit;
a virtual information generator that generates visual virtual information representing the risky situation based on the risky situation indication scenario;
an actual information controller that controls a motion of actual information in an actual environment in which the vehicle travels based on the risky situation indication scenario; and
a superimposing unit that superimpose the virtual information on a predetermined position in the image shot by the imaging unit.

2. The vehicle risky situation reproducing apparatus according to claim 1, wherein the driving action detector detects the driving action of the driver based on information indicating a position and an attitude of the vehicle, information indicating a physical condition of the driver, information indicating a performance of the vehicle, and information indicating a condition surrounding the vehicle.

3. The vehicle risky situation reproducing apparatus according to claim 1 further comprising:
a driving action database that stores a carelessness action or a dangerous action while driving and a carelessness and danger level of the carelessness action or the dangerous action of the driver,
wherein the scenario generator generates the risky situation indication scenario based on the detection result of the driving action detector, the calculation result of the vehicle position and attitude calculation unit, and the carelessness and dangerous level store in the driving action database.

4. A method of operating the vehicle risky situation reproducing apparatus according to claim 1, comprising:
recording the driving action detected by the driving action detector and the present position and the driving direction of the vehicle calculated by the vehicle position and attitude calculation unit when the virtual information is displayed on the image display unit; and
reproducing the recorded driving action and the recorded current position and traveling direction of the vehicle.

5. The method according to claim 4, further comprising:
displaying an image shot by the imaging unit, including real information visually presented to the diver of the vehicle or an image shot by the imaging unit on which the virtual information is superimposed; and
displaying visual information regarding driving to the driver of the vehicle.

6. The vehicle risky situation reproducing apparatus according to claim 2 further comprising:
a driving action database that stores a carelessness action or a dangerous action while driving and a carelessness and danger level of the carelessness action or the dangerous action of the driver,
wherein the scenario generator generates the risky situation indication scenario based on the detection result of the driving action detector, the calculation result of the vehicle position and attitude calculation unit, and the carelessness and dangerous level stored in the driving action database.
